(19) United States
(12) Patent Application Publication
(10) Pub. No.: US 2022/0116555 A1
(43) Pub. Date: Apr. 14, 2022

(54) REDUCING OPTICAL CROSSTALK EFFECTS IN SILICON-BASED PHOTOMULTIPLIERS

(71) Applicant: Universitat De Barcelona, Barcelona (ES)

(72) Inventors: David GASCÓN FORA, Barcelona (ES); Sergio GÓMEZ FERNÁNDEZ, Barcelona (ES); Joan MAURICIO FERRÉ, Barcelona (ES)

(21) Appl. No.: 17/532,589

(22) Filed: Nov. 22, 2021

Related U.S. Application Data
(63) Continuation of application No. PCT/EP2019/063569, filed on May 27, 2019.

(51) Int. Cl. H04N 5/359; H04N 5/378

(52) U.S. Cl. CPC H04N 5/359; H04N 5/378

(57) ABSTRACT

Silicon-based photomultipliers (SiPMs) for reducing optical crosstalk effects in the SiPMs are provided. The SiPMs include macrocells. Each macrocell includes microcells, coupled in parallel, and a reading circuit coupled to an output of each macrocell. The microcells are arranged in the SiPM so that adjacent microcells belong to different macrocells. When a microcell performs a detection, the reading circuit of each macrocell having one or more microcells adjacent to the microcell that performed the detection is configured to disable its output signal during a predefined period of time. PET devices or systems and methods for reducing crosstalk effects are also provided.

### CROSS-REFERENCE TO RELATED APPLICATIONS

This application is a continuation of International Application No. PCT/EP2019/063569. filed May 27, 2019, which claims the benefit and priority to European Application No. EP18382366.5, filed May 28, 2018.

### TECHNICAL FIELD

The present invention relates to the field of silicon-based photomultipliers (SiPM), and more specifically to techniques for reducing optical crosstalk effects in SiPMs.

### BACKGROUND

The present invention relates to photon detectors. In particular, the present invention relates to fast, high sensitivity photon detectors such as semiconductor photomultipliers, and to a readout method for semiconductor photomultipliers. In particular, but not exclusively, the present invention relates to semiconductor photomultipliers in such areas as positron emission tomography (PET), including time-of-flight PET (TOF-PET), laser imaging detection and ranging (LIDAR) applications, bio luminescence, and high energy physics (HEP) detectors.

PET systems usually comprise a plurality of photodetectors, e.g. SiPMs, configured to detect gamma rays and which enable creating a 3D image by tracing the trajectories of all detected gamma rays which may be used for diagnostic purposes. Known PET systems comprise a plurality of photodetectors having scintillator crystals (or other light generation materials) which may, upon an impingement of a gamma ray, create photons that are detected by the photodetectors, also called photosensors. The resolution (time and energy) of the photosensor is of upmost importance for TOF-PET. Enhanced resolution increases the signal to noise ratio of the image and allows reducing the exposure time of the patient and the cost per scan.

SiPMs are semiconductor photon sensitive devices made up of an array of very small Geiger-mode avalanche photodiode (APD) cells, also known as microcells or single photon avalanche diodes (SPAD), on a silicon substrate. The SiPM comprises a plurality of microcells which are located on a surface of said silicon substrate, for example, in an epitaxial layer. Each cell comprises an internal individual quenching resistor (or an active quenching by other type of electronics circuit) made of, for example, high resistivity polysilicon and located on top of a silicon oxide layer which covers all cells. In operation each cell is supplied with reverse bias that exceeds the break-down voltage. When a photon is absorbed in the cell, a Geiger discharge takes place, the discharge being limited by the quenching resistor.

One problem of these devices can be described as “optical crosstalk” wherein different forms of optical cross-talk can appear in the devices. One form of optical cross-talk originates from photons created in a Geiger discharge of a neighboring cell. The effect of an optical crosstalk event mainly affects adjacent microcells. The optical crosstalk may negatively affect the resolution of a SiPM, and consequently of the whole PET system. In particular, some studies (e.g. R. Dolenec et al, “SiPM timing at low light intensities,” NSS/MIC/RTSD, Strasbourg, 2016, pp. 1-5; and P. Lecoq, “Pushing the Limits in Time-of-Flight PET Imaging,” in IEEE Transactions on Radiation and Plasma Medical Sciences, vol. 1, no. 6, pp. 473-485, November 2017, doi: 10.1109/TRPMS.2017.2756674) have shown that time resolution of advanced TOF-PET system is completely determined by the time of arrival of the first few photons, i.e. less than 10 photons, and that the optical crosstalk largely degrades the time resolution, particularly for materials capable of prompt light emission.

To register the performed detections, the SiPM may comprise a counter for counting the detections performed and a register e.g. a memory device, to save the detections performed. However, some of the detections performed may be due to the photons generated by optical crosstalk events and thus, a simple counting of the total detections may take into account the false detections.

In order to avoid false detections due to optical crosstalk events, several solutions are known in which the crosstalk event is reduced. A solution to minimize the optical crosstalk generated by hot carriers in avalanche region is to produce narrow trenches between the microcells to block the photons generated within the avalanche area of one microcell against reaching the neighboring microcells. The trenches may be filled with light absorptive material. Nevertheless, technological limitations in the production of the trenches and other crosstalk sources (such as reflection at the back surface or side surface of the device) make necessary additional methods to reduce the effect of optical crosstalk.

US2016/0191829 A1, entitled “Systems and methods for minimizing SiPM signal propagation delay dispersion and improve timing”, discloses SiPMs that are not used for reducing optical crosstalk effects.

Thus, there is a need to provide SiPMs having a reduced optical crosstalk effect without increasing the manufacturing complexity.

### SUMMARY

In a first aspect, a SiPM for reducing optical crosstalk effects in the SiPM is provided. The SiPM comprises a plurality of macrocells, each macrocell comprising a plurality of microcells coupled in parallel, and a reading circuit coupled to an output of each macrocell. The microcells are arranged in the SiPM so that adjacent microcells belong to a different macrocell. When a microcell performs a detection, the reading circuit of each macrocell having one or more microcells adjacent to the microcell that performed the detection is configured to disable its output signal during a predefined period of time.

By having a SiPM comprising a reading circuit and in which the adjacent microcells are arranged in different macrocells, disabling (or “vetoing”) the output signals of such macrocells is performed during a predefined period of time in which a crosstalk event may occur. Therefore, the macrocells in which a false detection may occur due to the crosstalk effect may not be taken into account as the reading circuit facilitates the independent functioning of each macrocell output. As a result the effects of optical crosstalk events are avoided or at least substantially reduced.

In addition, when a SiPM is used in a PET imaging device, such as a PET-TOF device, the exposure time of a patient may be reduced as fewer trajectory lines may be needed to obtain the origin of the gamma rays i.e. to create a 3D image of the patient body.

In an example, each macrocell may be coupled to a delay circuit for delaying the disabling of the output signal of the macrocell, because in prompt light emission materials, such as Cherenkov radiators, the prompt light photons are typically emitted (few hundreds of picoseconds (ps)) before any crosstalk event occurs.

In an example, the microcells may comprise a rectangular, hexagonal or circular shape. Other cell shapes are also possible.

In an example, each macrocell may be coupled to a switching circuit. The switching circuit may disable the output signal of a macrocell during a period of time in which a crosstalk event may be expected and may subsequently enable said output signal.

In an example, the array may be a checkerboard array, i.e. alternating microcells where any two neighbouring microcells may belong to different macrocells.

In an example, each microcell may comprise a SPAD and may comprise also a quenching and/or recharge elements.

In an example, each SiPM or SiPM matrix may comprise a scintillation crystal or other prompt light emission materials, such as Cherenkov light radiators, nano-crystals or LYSO crystals.

Other aspects of the invention relate to a PET device and to an imaging system. Both the device and the system comprise one or more SiPMs according to any of the disclosed examples.

In another aspect, a method for reducing optical crosstalk effect in a SiPM is provided. The SiPM comprises a plurality of macrocells, each macrocell comprises a plurality of microcells electrically coupled in parallel and wherein adjacent microcells i.e. physically disposed side-by-side onto the device, belong to a different macrocell. The method comprises performing a detection by a microcell, identifying one or more macrocells of the microcells adjacent to the microcell that performed the detection, and disabling an output signal of the identified one or more macrocells during a predefined disabling period of time, e.g. during a period of time in which an optical crosstalk is expected.

In a SiPM read-out, different read out paths may exist. Some read out paths may be optimized to extract different parameters of the signal such as timing information, energy or charge information, photon counting, etc. The proposed method may or may not be applied in the different read-out paths independently. With the proposed method, the crosstalk-events will be largely reduced but some real photodetections might be lost. However, by limiting the number of microcells in a macrocell the SiPMs efficiency may be maintained high as the number of false positive detections may be reduced significantly while the number of false negative results (i.e. losing real photodetections) may be substantially limited.

In an example, the method may comprise identifying the disabling period of time during which an optical crosstalk event is expected and disabling the output signal of the identified one or more macrocells during the identified disabling period of time. This is because different types of SiPMs may have different expected optical crosstalk event times.

In an example, the method further comprises enabling the output signal of the identified one or more macrocells after the disabling period of time has expired.

In an example, disabling the output signal of one or more macrocells may be done a predetermined delay time after performing a detection. Thus the output of the affected macrocells may be disabled only for a minimum of time during which the optical crosstalk event may be expected.

### BRIEF DESCRIPTION OF DRAWINGS

Non-limiting examples of the present disclosure will be described in the following figures.

FIG. 1 schematically illustrates a SiPM according to an example.

FIG. 2 schematically illustrates a cross-sectional side view of a plurality of microcells according to an example.

FIGS. 3A and 3B schematically illustrate a circuit of a SiPM according to examples.

FIG. 4 schematically illustrates a plurality of microcells according to an example.

FIG. 5 schematically illustrates a flow chart of a method to reduce the optical crosstalk effects in a SiPM.

FIG. 6 schematically illustrates a PET device according to an example.

### DETAILED DESCRIPTION

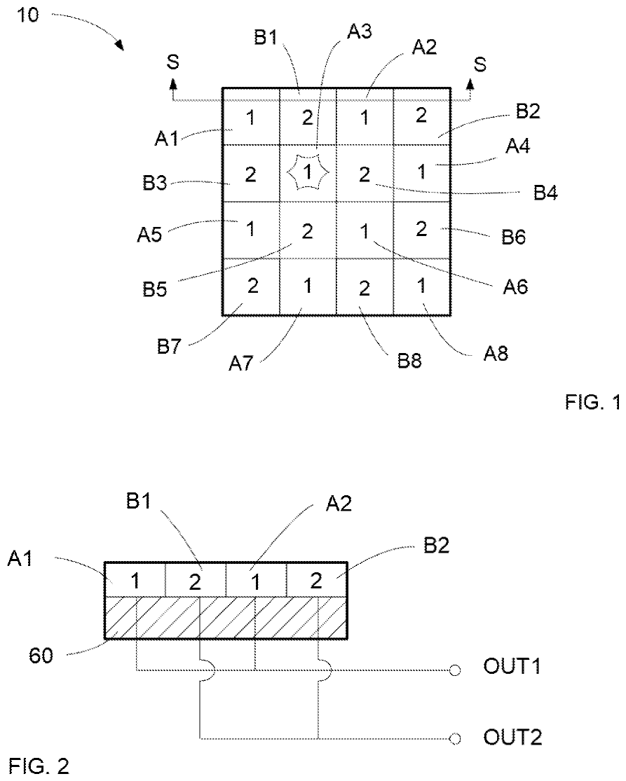

FIG. 1 shows a SiPM 10 which may comprise a plurality of microcells A1-A8 and B1-B8, e.g. 16 microcells, which may be arranged in a M×N array, e.g. a 4×4 array, which may comprise rows and columns. The microcells may be of any suitable shape e.g. square, circular, hexagonal, etc., and may be configured to perform e.g. photon detections.

Each microcell may comprise a photodiode e.g. a SPAD, and a scintillating crystal, e.g. Cherenkov radiators or other prompt light emission materials, LYSO crystals or any other suitable crystal, which may generate photons to be detected by the photodiode. In an example (see FIG. 2) a scintillating crystal may be placed under the microcell array, i.e. each SiPM may comprise a single scintillating crystal arranged underneath the structure. In another example, for instance, in a system comprising a plurality of SiPM, the system may comprise a single monolithic scintillating crystal arranged under the SiPMs.

The microcells may comprise a corresponding individual output through which a reading signal may be output.

The microcells of the SiPM 10 may be arranged in a plurality of macrocells e.g. two, three or any other suitable number of macrocells. Each macrocell may comprise a corresponding macrocell output to which all individual microcell outputs of the macrocell may be coupled in parallel.

In the example of FIG. 1, the SiPM 10 may comprise two different macrocells in which a number, e.g. 16, of microcells may be arranged in parallel. More specifically, the microcells A1-A8 may belong to a first macrocell 1, and the microcells B1-B8 may belong to a second macrocell 2. Each macrocell may comprise a corresponding output OUT1, OUT2 (see FIG. 2) to which the output of every microcell in the macrocell may be electrically coupled, i.e. the microcells belonging to the same macrocell may have their corresponding outputs coupled to a common macrocell output.

Having the outputs of each microcell of a macrocell coupled to a common macrocell output may not involve an increased complexity of the circuitry connections and may facilitate the independent functioning of each macrocell, i.e. the contribution of a macrocell may be disabled or vetoed (i.e. detections may still be performed but they are not read).

The microcells may be arranged in such a way, e.g. in a checkerboard pattern, that the adjacent microcells of any macrocell i.e. the microcells in contact with at least a portion of a side of the microcell, belong to a different macrocell. Said in another way, two microcells may need to share a common border for at least above a predefined threshold in order to be considered adjacent. Such threshold may be defined by the expected probability of a crosstalk event between the two border-sharing microcells. A larger common border may involve a higher probability whereas a shorter common border a lower probability. For borders only coinciding at a point or vertex, e.g. diagonally arranged microcells such as A1 and A3 in FIG. 1, a probability of having a crosstalk event may be considered low. Thus A1 and A3 may belong to the same macrocell. Therefore, the adjacent microcell of the microcell A3 which may belong to the first macrocell 1 would be four microcells, i.e. the microcells B1, B3, B4 and B5, which may be arranged in the second macrocell 2.

In an example, a detection may be performed by the microcell A3 arranged on the first macrocell 1. A possible optical crosstalk event may mainly affect the adjacent microcells B1, B3, B4 and B5 belonging to the macrocell 2. In order to reduce the effect of a crosstalk event, i.e. false detections, when a detection is performed in a specific microcell, e.g. A3, the output of the macrocell(s) in which adjacent microcells are arranged may be disabled, e.g. macrocell 2. The complexity of wiring connections of the SiPM is therefore not increased. In the example of FIG. 2, the output of the macrocell 2 in which the adjacent microcell B1, B3, B4 and B5 are arranged may be disabled.

The output of the macrocell(s) other than the macrocell in which a microcell performs a detection may be disabled immediately after the detection or, as the crosstalk event may not occur instantly, the output of the macrocell(s) may be disabled after a predetermined delay time of e.g. 50-250 ps. The predetermined delay time may correspond to the time in which the crosstalk effect is expected to begin. Such time may differ according to SiPM type.

The output of macrocells in which adjacent microcells are arranged may be disabled during a predefined disabling period of time, e.g. between few hundreds of ps and few nanoseconds (ns), in which a significant fraction of optical crosstalk events may be expected and/or the critical timing measurement has been performed. Upon expiry of the disabling period, the output of the macrocell(s) to which adjacent microcells B1, B3, B4 and B5 belong, may be re-enabled.

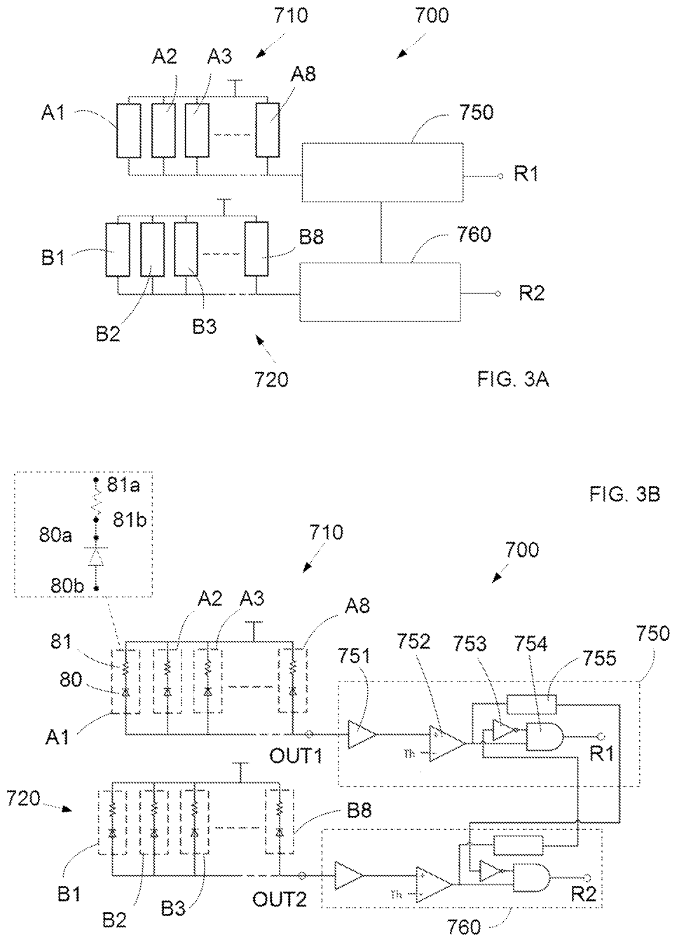

The SiPM 10 may further comprise a reading circuit (see FIGS. 3A and 3B) which may be coupled to the output of the macrocell so as to receive an output signal. The SiPM may comprise as many reading circuits as macrocells in the SiPM, for instance, in the example of FIG. 1 the SiPM 10 may comprise two reading circuits (not shown), each coupled to a macrocell.

The reading circuit of a macrocell having the microcell that performed the detection is configured to trigger the disabling of the output signal, during a first predefined period of time, of macrocells having one or more microcells adjacent to the microcell that performed the detection. The reading circuits may also be configured to delay the triggering of said disabling of the output signal a second predetermined period of time after which the crosstalk event is expected to begin.

In an example, the macrocells may comprise as few microcells as possible in order to limit the false negative results, thus, a high number of macrocells may be needed in each SiPM. With fewer microcells per macrocell efficiency is increased, i.e. less real photodetections may be lost.

FIG. 2 depicts a cross-section of some of the microcells of the SiPM of FIG. 1 taken along the line S-S. The SiPM may comprise a scintillating crystal 60 arranged under the microcells. The microcells may be arranged in two macrocells, i.e. a first macrocell 1 and a second macrocell 2. Each microcell may comprise an individual output which may be coupled to the corresponding common macrocell output OUT1, OUT2. That is, the microcells A1 and A2 may be arranged in the first macrocell 1 and their respective outputs may be coupled to the common macrocell output OUT1, and similarly, the outputs of microcells B1 and B2 may be coupled to the macrocell output OUT2. By coupling all individual microcell outputs to a same macrocell output, the electronic implementation of the connecting elements and their connections may not have an increased complexity.

FIG. 3A depicts a simplified schematic view of an example of an electronic circuit 700 of the SiPM of FIG. 1. The circuit 700 may comprise sub-circuits 710, 720 which may correspond to the number of macrocells e.g. two macrocells. The sub-circuit 710 may correspond to a first macrocell 1 which may comprise eight microcells A1-A8 coupled in parallel. The sub-circuit 720 may correspond to the microcells B1-B8 of macrocell 2 which may also be coupled in parallel.

The circuit 700 may further comprise reading circuits 750, 760 electrically coupled to each macrocell output i.e. there may be as many reading circuits as macrocells. The reading circuits may comprise a reading output R1, R2 through which e.g. the output signals of each macrocell may be read or the signal of other macrocells may be disabled. The reading circuits 750, 760 may thus be interconnected.

Each reading circuit may comprise a switching circuit which may be configured to disable the reading output e.g. by setting to zero the reading output despite any detection performed. The reading output may be disabled during a predetermined disabling period of time in which crosstalk events may be expected. The switching circuit may be triggered by another macrocell or by a separate or external switching controller.

The reading circuits may further comprise a delay circuit which may be configured to delay the disabling of the reading output after a detection is performed by another macrocell.

FIG. 3B depicts a simplified schematic view of an example of an electronic circuit 700 of the SiPM of FIG. 1. The circuit 700 may comprise sub-circuits 710, 720 which may correspond to the number of macrocells. In the example of FIG. 3B, the circuit may comprise two sub-circuits which may correspond to two macrocells. The sub-circuit 710 may correspond to a first macrocell 1 which may comprise eight microcells A1-A8 coupled in parallel. The sub-circuit 720 may correspond to the microcells B1-B8 of macrocell 2 which may also be coupled in parallel.

Each microcell may comprise a photodiode 80 which may have two terminals 80a and 80b; and a resistor 81 which may have two terminals 81a and 81b (see the amplified section).

Terminal 81a of the resistor 81 may be coupled to an output terminal coupled to a voltage or a current source. Terminal 81b of the resistor 81 may be coupled to terminal 80a of photodiode 80.

Terminal 80b of photodiode 80 may be coupled to group output OUT1.

In an example, resistor 81 may be an active circuit. In another example, resistor 81 may be coupled to terminal 80a or to terminal 80b of photodiode 80.

In an example the output of photodiode 80 may either be terminal 81a of resistor 81 or terminal 80b of the photodiode. In an example, the output may even be terminal 80a if the resistor 81 is coupled to terminal 80b of photodiode 80.

The circuit 700 may further comprise reading circuits 750, 760 coupled to each macrocell output OUT1, OUT2 i.e. there may be as many reading circuits as macrocells. The reading circuits may comprise a reading output R1, R2 through which the output signals of each macrocell may be read.

Each reading circuit may comprise a switching circuit which may be configured to disable the reading output e.g. by setting to zero the reading output despite any detection performed. The reading output may be disabled during a predetermined disabling period of time in which crosstalk events may be expected.

The reading circuits may further comprise a delay circuit which may be configured to delay, e.g. about 50-200 ps, the disabling of the reading output after a detection is performed. In an example, the delay circuit may comprise a monostable timer.

In an example, a reading circuit 750 may comprise an amplifier 751, a discriminator 752, a NOT gate 753, an AND gate 754 and a monostable timer 755.

The input of the amplifier 751 may be coupled to the macrocell output OUT1. The output of the amplifier 751 may be coupled to a first input of the discriminator 752.

A second input of the discriminator 752 may be coupled to a threshold signal. The output of the discriminator 752 may be coupled to the input of the monostable timer 755 and to a first input of AND gate 754.

The output of the monostable timer 755 may be coupled to the input of NOT gate of sub-circuit 760.

A second input of the AND gate 754 may be coupled to the output of the NOT gate 753. The output of the AND gate 754 may be coupled to the reading output R1.

The input of NOT gate 753 may be coupled to the output terminal of the monostable timer of sub-circuit 760.

The reading circuit 750 described herein is only one possible implementation. It is understood that other implementations are also possible that may provide a similar effect.

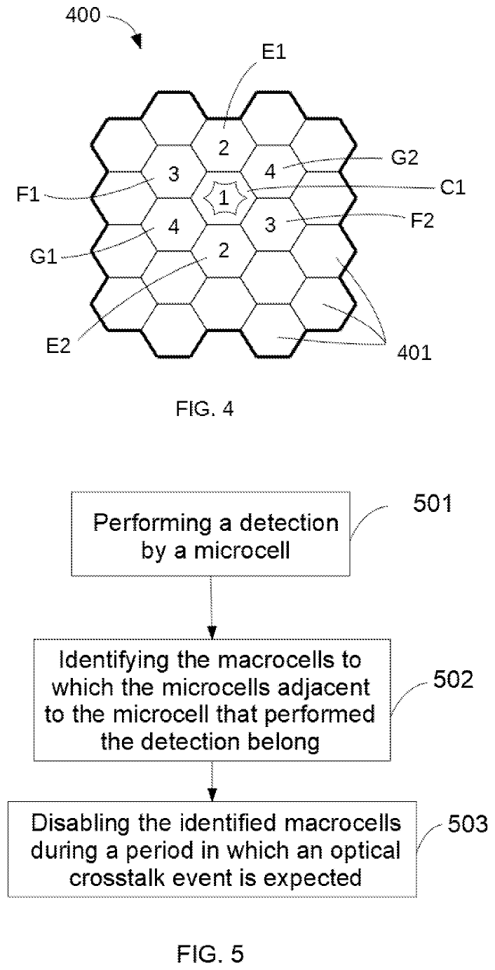

FIG. 4 depicts an example of a SiPM 400 which may comprise a plurality of hexagonal microcells 401, e.g. 32 microcells, arranged in a plurality of macrocells, e.g. 4. In the example, the microcell C1, in which a detection may be performed, may belong to a first macrocell 1. The adjacent microcells of microcell C1 may belong to different macrocells, particularly E1 and E2 to a second macrocell 2, F1 and F2 to a third macrocell 3; and the G1 and G2 to a fourth macrocell. Therefore, upon performing a detection, the output of macrocells 2-4 may be disabled because they have microcells sharing a portion of a border, in the particular case one of the six sides of the hexagon, with the microcell C1 that performed the detection.

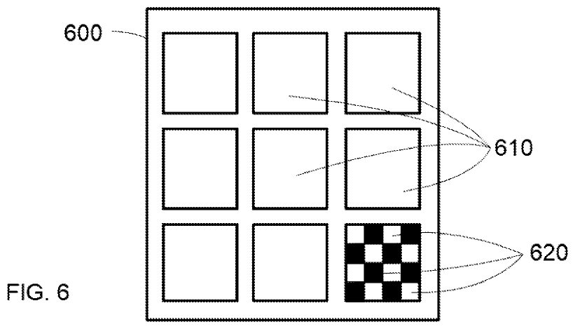

FIG. 5 depicts a flow chart of a method for reducing the crosstalk effect in a SiPM which may comprise a plurality of microcells. Such microcells may belong to different macrocells and may be arranged in a way e.g. a checkerboard pattern, in which adjacent microcells do not belong to the same macrocell. In block 501, a microcell arranged in a macrocell may perform a detection. Then, in block 502, the macrocells to which the microcells adjacent to the microcell that performed the detection belong may be identified. In order to reduce the effects of a possible optical crosstalk event, the output of the identified macrocells may be disabled, in block 503, during a period in which an optical crosstalk effect is expected. Such disabling may occur immediately after the detection or may be delayed a predefined delay time which may be selected based on the characteristic of the SiPM, e.g. about 50-250 ps. Then, while the outputs of some macrocells are disabled, the reading outputs of non-disabled macrocell may still be read and registered. The total number of detections performed by such specific macrocells may therefore be registered when the outputs of other macrocells are disabled. After the disabling period of time, the disabled outputs may be re-enabled.

FIG. 6 shows an imaging system 600, e.g. a PET scanner or PET imaging device, a LIDAR or a fluorescence-lifetime imaging microscopy (FLIM) system, which may comprise a plurality of SiPMs 610 according to any of the disclosed examples. The SiPMs 610 may comprise a plurality of microcells 620 arranged in macrocells, e.g. in a checkerboard pattern. The alternating black and white boxes in FIG. 6 represent the microcells 620. The microcells depicted in white colour may belong to one macrocell whereas the microcells depicted in black colour may belong to another macrocell.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow. If reference signs related to drawings are placed in parentheses in a claim, they are solely for attempting to increase the intelligibility of the claim, and shall not be construed as limiting the scope of the claim.

What is claimed is:

1. A silicon-based photoelectric multiplier (SiPM) for reducing optical crosstalk effects in the SiPM, the SiPM comprising:
a plurality of macrocells, each macrocell comprising a plurality of microcells coupled in parallel, and
a plurality of reading circuits, each coupled to an output of a macrocell to receive an output signal of the macrocell; wherein
the microcells are arranged in the SiPM so that adjacent microcells belong to a different macrocell, and
when a microcell performs a detection, the reading circuit of each macrocell having one or more microcells adjacent to the microcell that performed the detection is configured to disable its output signal during a predefined period of time.

2. The SiPM according to claim 1, wherein each macrocell is coupled to a delay circuit for delaying the disabling of the output signal of the macrocell.

3. The SiPM according to claim 1, wherein the microcells comprise a rectangular, hexagonal or circular shape.

4. The SiPM according to claim 1, wherein each macrocell is coupled to a switching circuit.

5. The SiPM according to claim 1, wherein the array is a checkerboard array.

6. The SiPM according to claim 1, wherein each microcell comprises a single-photon avalanche diode.

7. The SiPM according to claim 1, wherein each SiPM comprises a scintillation crystal or other prompt light emission material.

8. An imaging system comprising one or more SiPMs according to claim 1.

9. The imaging system according to claim 8, comprising one of a positron emission tomography device, a laser imaging detection and ranging, and a fluorescence-lifetime imaging microscopy.

10. A method for reducing optical crosstalk effect in a SiPM, the SiPM comprising a plurality of macrocells, each macrocell comprising a plurality of microcells coupled in parallel, wherein adjacent microcells belong to a different macrocell, the method comprising the steps of:
performing a detection by a microcell;
identifying one or more macrocells of the microcells adjacent to the microcell that performed the detection; and
disabling an output signal of the identified one or more macrocells during a predefined disabling period of time.

11. The method according to claim 10, further comprising triggering the disabling of the output signal of macrocells having one or more microcells adjacent to the microcell that performed the detection, by the reading circuit of the macrocell having the microcell that performed the detection

12. The method according to claim 10, further comprising:
identifying the disabling period of time during which an optical crosstalk event is expected; and
disabling the output signal of the identified one or more macrocells during the identified disabling period of time.

13. The method according to claim 10, further comprising enabling the output signal of the identified one or more macrocells after the disabling period of time has expired.

14. The method according to claim 10, wherein disabling the output signal of one or more macrocells is done a predetermined delay time after performing a detection.

15. The method according to claim 14, wherein the delay time for disabling the output of the one or more macrocells is between 50 and 250 ps.
